(19) United States
(12) Patent Application Publication
(10) Pub. No.: US 2017/0364037 A1
(43) Pub. Date: Dec. 21, 2017

(54) Method for Setting Alarm Clock, Electronic Terminal, and System

(71) Applicant: Huawei Technologies Co., Ltd., Shenzhen (CN)

(72) Inventors: Xiaofeng Liu, Shenzhen (CN); Lisha Ge, Shenzhen (CN)

(21) Appl. No.: 15/540,213

(22) PCT Filed: Dec. 29, 2014
(86) PCT No.: PCT/CN2014/095382

§ 371 Date: Jun. 27, 2017

(51) Int. Cl. G04G 13/02; H04M 1/21

(52) U.S. Cl. CPC G04G 13/023; H04M 1/21

(57) ABSTRACT

A method of implementing an alarm clock, an electronic terminal and a system, where the method is applied to an electronic terminal, and includes obtaining a use end time of the electronic terminal, obtaining an alarm time of the electronic terminal, determining a time difference from the use end time to the alarm time, and determining an alarm manner of the electronic terminal according to the time difference, thereby increasing flexibility of an alarm manner of an alarm clock.

### CROSS-REFERENCE TO RELATED APPLICATION

This application is a U.S. National Stage of International Patent Application No. PCT/CN2014/095382 filed on Dec. 29, 2014, which is hereby incorporated by reference in its entirety.

### TECHNICAL FIELD

The present disclosure relates to the field of electronic technologies, and in particular, to a method for setting an alarm clock, an electronic terminal, and a system.

### BACKGROUND

Many existing electronic terminals such as mobile phones and personal digital assistants (PDAs) have a function of providing time and date. On the basis of time and date, many electronic terminals also provide alarm clock functions such that users set time to achieve an objective of event reminding.

Currently, a manner of implementing an alarm clock in an electronic terminal is mainly includes that any quantity of alarm clocks and an alarm clock of any alarm time may be set according to a user's requirement (referring to FIG. 8). At a preset alarm time, an alarm clock rings to remind the user. After the user confirms cancellation of the alarm clock, the alarm clock is disabled.

However, currently this alarm clock wake-up manner lacks flexibility, and cannot provide an intelligent and personalized alarm clock wake-up manner to users.

### SUMMARY

In view of this, embodiments of the present disclosure provide a method for setting an alarm clock, an electronic terminal, and a system in order to increase flexibility of an alarm clock wake-up manner.

In order to achieve the foregoing objective, the following technical solutions are used in the embodiments of the present disclosure.

According to a first aspect, a manner of implementing an alarm clock is provided, including obtaining a use end time of an electronic terminal, obtaining an alarm time of the electronic terminal, determining a time difference from the use end time to the alarm time, and determining an alarm manner of the electronic terminal according to the time difference.

In a first possible implementation manner of the first aspect, obtaining a use end time of an electronic terminal includes obtaining the use end time of the electronic terminal after the electronic terminal enters a determining time.

With reference to the first aspect or the first possible implementation manner of the first aspect, in a second possible implementation manner, obtaining a use end time of an electronic terminal includes obtaining the use end time of the electronic terminal when a use time is greater than a preset time value.

In a third possible implementation manner of the first aspect, obtaining an alarm time of the electronic terminal includes that the alarm time is an alarm time of an alarm clock that is selected by a user.

In a fourth possible implementation manner of the first aspect, determining an alarm manner of the electronic terminal according to the time difference includes determining that the electronic terminal uses the first alarm manner when the time difference is less than a first threshold.

With reference to the first aspect or the fourth possible implementation manner of the first aspect, in a fifth possible implementation manner, determining an alarm manner of the electronic terminal according to the time difference includes determining that the electronic terminal uses a second alarm manner when the time difference is greater than the first threshold.

In a sixth possible implementation manner of the first aspect, when the time difference is greater than a second threshold, the method further includes clearing the obtained use end time of the electronic terminal, and/or determining that the alarm manner of the electronic terminal is a regular alarm manner.

In a seventh possible implementation manner of the first aspect, when the alarm time passes in the electronic terminal, the method further includes clearing the obtained use end time of the electronic terminal, and/or determining that the alarm manner of the electronic terminal is a regular alarm manner.

According to a second aspect, an electronic terminal is provided, where the electronic terminal includes a first obtaining unit configured to obtain a use end time of the electronic terminal, a second obtaining unit configured to obtain an alarm time of the electronic terminal, a first determining unit configured to determine a time difference from the use end time to the alarm time, and a second determining unit configured to determine an alarm manner of the electronic terminal according to the time difference.

In a first possible implementation manner of the second aspect, the first obtaining unit is configured to obtain the use end time of the electronic terminal after the electronic terminal enters a determining time.

In a second possible implementation manner of the second aspect, the first obtaining unit is configured to obtain the use end time of the electronic terminal when a use time is greater than a preset time value.

In a third possible implementation manner of the second aspect, the second obtaining unit is configured to obtain the alarm time of the electronic terminal, and the alarm time is an alarm time of an alarm clock that is selected by a user.

In a fourth possible implementation manner of the second aspect, the second determining unit further includes a first subunit configured to determine that the electronic terminal uses a first alarm manner when the time difference is less than a first threshold.

In a fifth possible implementation manner of the second aspect, the second determining unit further includes a second subunit configured to determine that the electronic terminal uses a second alarm manner when the time difference is greater than a first threshold.

In a sixth possible implementation manner of the second aspect, the electronic terminal further includes a first clearing unit configured to clear the obtained use end time of the electronic terminal, or determine that the alarm manner of the electronic terminal is a regular alarm manner when the time difference is greater than a second threshold.

In a seventh possible implementation manner of the second aspect, the electronic terminal further includes a second clearing unit configured to clear the obtained use end time of the electronic terminal, or determine that the alarm manner of the electronic terminal is a regular alarm manner when the alarm time passes in the electronic terminal.

According to a third aspect, an alarm clock system is provided, where the system includes a first electronic terminal and a second electronic terminal, where the first electronic terminal includes a first obtaining unit configured to obtain a use end time of the electronic terminal, and a first sending unit configured to send the use end time of the first electronic terminal to the second electronic terminal, and the second electronic terminal includes a first receiving unit configured to receive the use end time of the first electronic terminal, a second obtaining unit configured to obtain an alarm time of the second electronic terminal, a first determining unit configured to determine a time difference from the use end time to the alarm time, and a second determining unit configured to determine an alarm manner of the second electronic terminal according to the time difference.

According to a fourth aspect, an electronic terminal is provided, including a processor and a memory, where the processor reads executable program code stored in the memory to run a program corresponding to the executable program code in order to obtain a use end time of the electronic terminal, obtain an alarm time of the electronic terminal, determine a time difference from the use end time to the alarm time, and determine an alarm manner of the electronic terminal according to the time difference.

By means of the method for setting an alarm clock and the electronic terminal provided in the embodiments of the present disclosure, before an alarm clock rings, a time when the terminal is used for a last time is first obtained, and if a time difference from the time when the terminal is used for the last time to a time of the alarm clock is greater than a threshold, flexibility of an implementation manner of an alarm clock can be increased.

### BRIEF DESCRIPTION OF DRAWINGS

In order to describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic flowchart of a method for setting an alarm clock according to an embodiment of the present disclosure;

FIG. 2 is a schematic flowchart of a method for setting an alarm clock according to an embodiment of the present disclosure;

FIG. 3 is a schematic structural diagram of an electronic terminal according to an embodiment of the present disclosure;

FIG. 4 is a schematic structural diagram of a second determining unit according to an embodiment of the present disclosure;

FIG. 5 is a schematic structural diagram of an electronic terminal according to an embodiment of the present disclosure;

FIG. 6 is a schematic structural diagram of an alarm clock system according to an embodiment of the present disclosure;

FIG. 7 is a schematic structural diagram of an electronic terminal according to an embodiment of the present disclosure;

FIG. 8 is an alarm clock setting interface in an electronic terminal; and

FIG. 9 is an alarm clock setting interface in an electronic terminal according to an embodiment of the present disclosure.

### DESCRIPTION OF EMBODIMENTS

The following clearly describes the technical solutions in the embodiments of the present disclosure with reference to the accompanying drawings in the embodiments of the present disclosure. It should be understood that, the described embodiments are merely some but not all of the embodiments of the present disclosure. All other embodiments obtained by a person of ordinary skill in the art based on the embodiments of the present disclosure without creative efforts shall fall within the protection scope of the present disclosure.

The following description and drawings use an example in which an alarm clock is applied to an electronic terminal such as a mobile phone, a smartphone, a wearable device, an e-reader, or a PDA. It may be understood that the electronic terminal is not limited to the content listed in the foregoing.

An electronic terminal may include a control circuit such as a processor and a memory, and may further include a hard disk, a nonvolatile memory, a volatile memory, and the like. A control circuit may be based on one or more microprocessors, microcontrollers, digital signal processors, baseband processors, audio codec chips, application-specific integrated circuits, power supply management units, or the like. An electronic terminal further includes a timer, an audio output device, a vibrator, and the like.

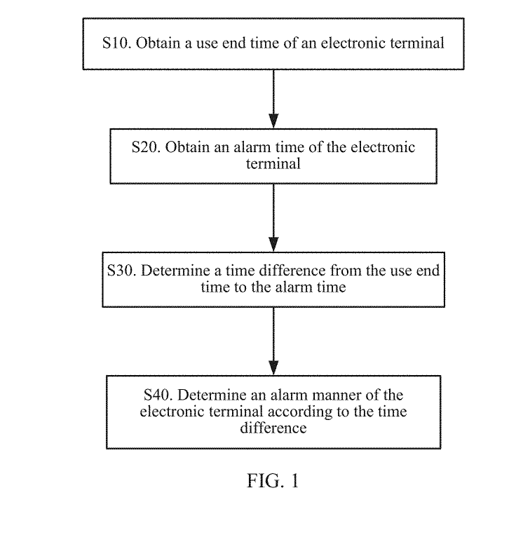

FIG. 1 shows a method for setting an alarm clock according to Embodiment 1 of the present disclosure. The method for setting an alarm clock includes the following steps.

Step S10: Obtain a use end time of an electronic terminal.

The use end time is used to indirectly reflect a time when a user stops using the electronic terminal. Although a time when the user actually stops using the electronic terminal is difficult to determine, the use end time of the electronic terminal may be used to infer the time when the user stops using the electronic terminal. The use end time of an electronic terminal may be a time when the electronic terminal enters a standby state, or may be a time when a screen of the electronic terminal with a display is turned off, or a time when the electronic terminal enters a lock screen, or may further be a time when the electronic terminal detects that the user closes a protective case if the electronic terminal has the protective case.

A mobile phone is used as an example. The mobile phone stays in a use state when the user keeps using the mobile phone. The mobile phone enters a standby state according to a setting of the mobile phone when the user presses a power off button, or the user does not perform any operation for a long time

The obtained use end time of the electronic terminal may be stored in a memory, and a processor invokes stored code to obtain the stored use end time of the electronic terminal. The method is known by persons of ordinary skill in the art, and details are not described herein again.

Step S20: Obtain an alarm time of the electronic terminal.

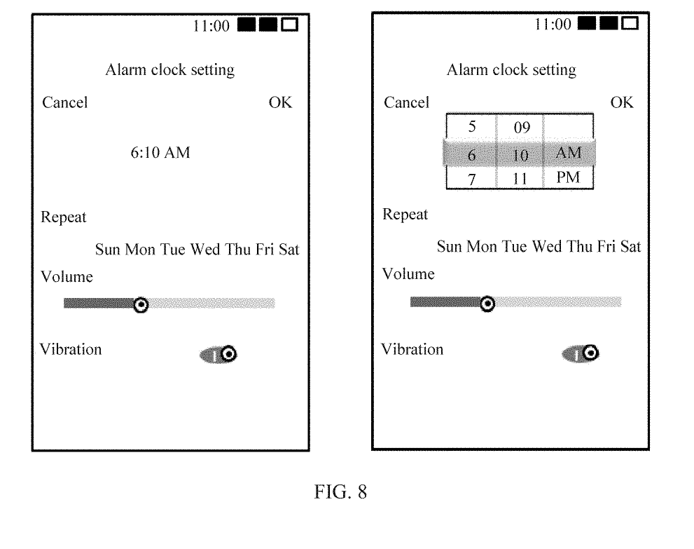

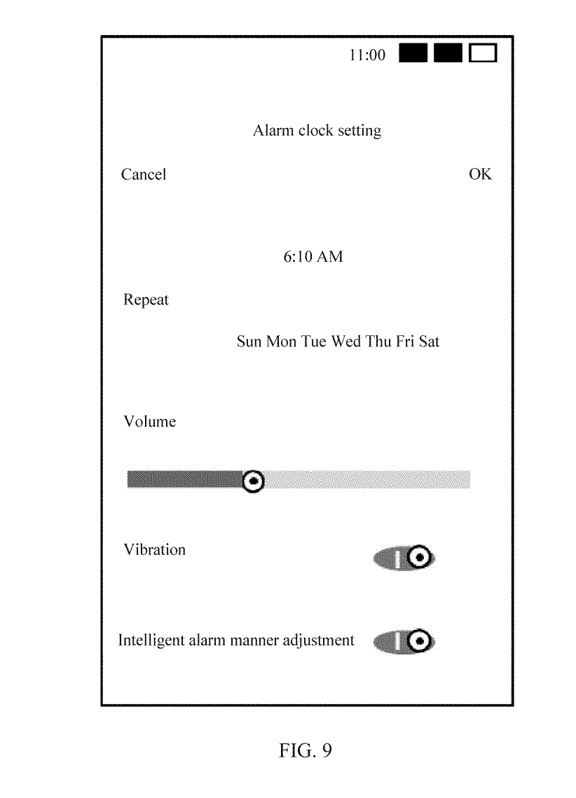

The alarm time may be preset by a user. As shown in FIG. 8 and FIG. 9, the electronic terminal includes a display screen, content of alarm clock settings is included on the display screen. A user may determine an alarm time of the electronic terminal by entering a time value or dragging a slider on a time scrollbar. The alarm time may be one or more.

An alarm time may be stored in a memory, and a processor calls stored code to obtain the stored alarm time. The method is known by persons of ordinary skill in the art, and details are not described herein again.

It should be noted that step S10 and step S20 are not arranged in a specific order.

Step S30: Determine a time difference from the use end time to the alarm time.

The time difference may be obtained according to the obtained use end time and the obtained alarm time. For example, the use end time of the electronic terminal is 10:00 p.m., and the alarm time is 6:00 a.m. In this case, the time difference from the use end time to the alarm time is eight hours. In this embodiment of the present disclosure, the method for determining the time difference from the use end time to the alarm time may be implemented invoking a preset piece of code by a processor.

Step S40: Determine an alarm manner of the electronic terminal according to the time difference.

The alarm manner includes any one or a combination of a ringing volume, alarm duration, a quantity of times that an alarm repeats, a ringtone type, and whether vibration is enabled.

In the other approaches, after a user sets a wake-up alarm clock with an alarm time of 6:30 a.m., and set a volume of the alarm clock to “medium”, the alarm clock wakes up the user with the volume at 6:30 every morning, which lacks flexibility. For example, sometimes the user goes to bed at 2:00 a.m., and goes into deep sleep at 6:30 a.m. Therefore, it may be difficult to wake up the user with the medium volume. Sometimes the user goes to bed at 9:00 p.m., and in the next morning, the medium volume is too loud, producing noisy. In this case, this embodiment of the present disclosure provides a method such that an electronic terminal can determine that the electronic terminal uses different alarm manners according to a time difference from a use end time to an alarm time, which increases flexibility of an alarm manner of an alarm clock.

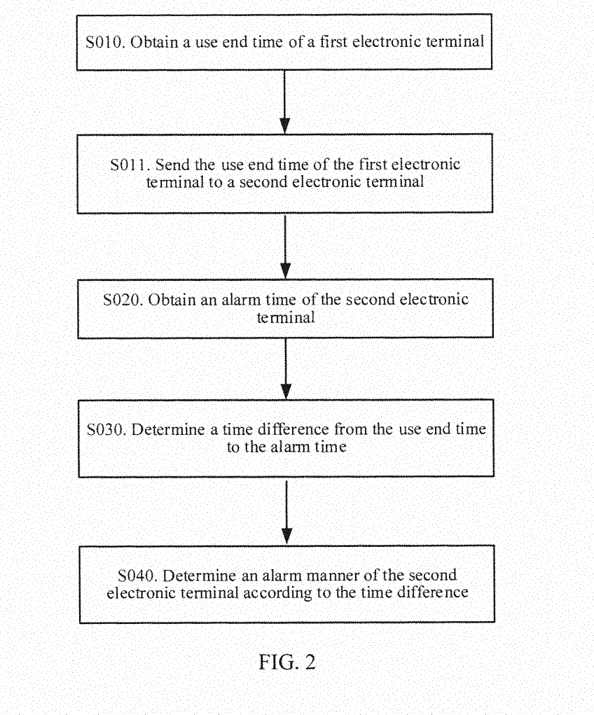

In order to further increase flexibility of alarm clock wake-up, FIG. 2 shows a method for setting an alarm clock for multiple terminals according to this embodiment of the present disclosure such that determining a use end time of a user and executing alarm clock wake-up are separately performed on different subjects. The method includes the following steps.

Step S010: Obtain a use end time of a first electronic terminal.

In a specific embodiment, reference may be made to the foregoing step S10 for the step S010 of obtaining a use end time of a first electronic terminal, and details are not described herein again.

Step S011: Send the use end time of the first electronic terminal to a second electronic terminal.

The first electronic terminal may be a mobile phone, a Pad, a wearable device, or any other electronic terminal. The second electronic terminal may be a mobile phone, a Pad, a wearable device, or any other electronic terminal. The first electronic terminal and the second electronic terminal may be of a same type, or may be of different types, which is not limited in this embodiment of the present disclosure.

The sending method in step S011 includes a data transmission method that uses BLUETOOTH, WI-FI, data traffic or any other manner. Correspondingly, the second electronic terminal can receive the use end time of the first electronic terminal.

Step S020: Obtain an alarm time of the second electronic terminal.

The second electronic terminal obtains an alarm time of the second electronic terminal. Reference may be made to the forgoing step S20 for the step S020 of obtaining an alarm time of the second electronic terminal, and details are not described herein again.

Step S030: Determine a time difference from the use end time to the alarm time.

Reference may be made to the foregoing step S30 for step S030, and details are not described herein again.

Step S040: Determine an alarm manner of the second electronic terminal according to the time difference.

Reference may be made to the foregoing step S40 for step S040, and details are not described herein again.

By means of the method provided in this embodiment of the present disclosure, an electronic device of which a use end time of a user is determined may be different from an electronic device that wakes up the user. The second electronic terminal may determine different alarm manners of the second electronic terminal according to a time difference from the use end time of the first electronic terminal to the alarm time of the second electronic terminal, thereby further increasing flexibility of alarm clock wake-up.

An embodiment of the present disclosure further provides a method for setting an alarm clock. The method for setting an alarm clock includes the following steps.

Step S101: Obtain a use end time of an electronic terminal.

The step S101 further includes obtaining the use end time of the electronic terminal after the electronic terminal enters a determining time.

The determining time refers to a preset time of the electronic terminal. A user may frequently use the electronic terminal. If every time after the use end time of the electronic terminal is obtained, the use end time needs to be compared with an alarm time, and a time difference between the use end time and the alarm time needs to be calculated to determine an alarm manner, power consumption of the electronic terminal is increased. Therefore, in this embodiment of the present disclosure, the electronic terminal first determines whether the electronic terminal enters a determining time. If the electronic terminal enters the determining time, the electronic terminal obtains a use end time of the electronic terminal, thereby reducing power consumption. Further, the electronic terminal may determine, using a built-in timer, whether the electronic terminal enters the determining time.

The determining time may be set by the user, or may be preset in a system. The determining time may be set to a relative value related to the alarm time. For example, the alarm time is 6:00 am, and the determining time is set to a time that is 5 minutes earlier than the alarm time, and then the electronic terminal starts at 5:55 to obtain a most recent use end time of the electronic terminal that is stored in a memory.

Optionally, on a user interface of the electronic terminal, an option of setting a determining time is provided such that the user may set the determining time by entering a time value, dragging a slider on a time scrollbar, or other manners.

In order to improve accuracy of the obtained use end time, optionally, when a use time is greater than a preset time value, the use end time of the electronic terminal is obtained.

The use time refers to duration of using the electronic terminal by the user. The use time may be a power-on time, a time when a screen is turned on, or a time that an application program runs, which is not limited in this embodiment of the present disclosure.

In the foregoing embodiment, every time after the electronic terminal is used, a use end time of the electronic terminal needs to be obtained, which may consume power of the electronic terminal, and may result in that the electronic terminal falsely performs determining. For example, an alarm time of an alarm clock is 6:00 a.m., and a user turns off a mobile phone after finishing watching a movie at 10:00 p.m. and goes to bed, and then a use end time obtained by the mobile phone is 10:00 p.m. However, the user may suddenly wake up at 2:00 a.m. and look at a time on the mobile phone, and then turn off the mobile phone. In this case, a time of using the mobile phone by the user at the latter time is only a few seconds. In this case, if the mobile phone obtains the use end time of the latter time, an alarm manner is changed, and a sleep time of the user may be falsely determined. In order to overcome these problems, before obtaining the use end time of the electronic terminal, whether a use time of the electronic terminal device at a current time is greater than a preset time value is determined first, and the use end time is obtained only when a condition is met. The preset time value may be set to 5 minutes, 10 minutes, or the like, which is not limited in this embodiment of the present disclosure. Further, the electronic terminal may calculate the use time of the electronic terminal using a built-in timer, and determine whether the use time is greater than the preset time value using a processor or other circuits having a determining function.

In a specific embodiment, refer to the foregoing step S10 for the step of obtaining a use end time of an electronic terminal, and details are not described herein again.

Step S201: Obtain an alarm time of the electronic terminal.

The step S201 further includes that the alarm time refers to an alarm time of an alarm clock that is selected by a user.

It may be understood that, a user may set multiple alarm clocks, but an alarm manner does not need to be adjusted for every alarm clock according to this embodiment of the present disclosure. For example, the user sets two alarm clocks. One is a wake-up alarm clock, and the other is an alarm clock for a meeting. In this case, the solution provided in this embodiment of the present disclosure may need to be used for only the wake-up alarm clock. Therefore, the electronic terminal may provide an option on a user interface of the electronic terminal for selection by the user. For example, on an interface shown in FIG. 9, an option box is provided. After a user selects “alarm manner intelligent adjustment”, the electronic terminal uses the method provided in this embodiment of the present disclosure to determine an alarm manner of the alarm clock. For an alarm clock that is not selected, the solution in the other approaches is still used. Therefore, flexibility of the solution is further improved.

Step S301: Determine a time difference from the use end time to the alarm time.

In a specific embodiment, reference may be made to the foregoing step S30 for step S301, and details are not described herein again.

Step S401: Determine an alarm manner of the electronic terminal according to the time difference.

Optionally, step 401 includes determining that the electronic terminal uses a first alarm manner when the time difference is less than a first threshold, and determining that the electronic terminal uses a second alarm manner when the time difference is greater than the first threshold.

Optionally, a volume of the first alarm manner is greater than a volume of the second alarm manner.

Optionally, music of the first alarm manner is different from music of the second alarm manner.

Optionally, the first alarm manner includes vibration, and the second alarm manner does not include vibration.

It may be understood that the foregoing first alarm manner and second alarm manner may be combined or divided in order to diversify alarm manners.

It should be noted that, in the foregoing solution, “greater than” includes a case of “greater than or greater than or equal to”, and “less than” includes a case of “less than or less than or equal to”.

Further, when the time difference is greater than a second threshold, the obtained use end time of the electronic terminal is cleared, and/or the alarm manner of the electronic terminal is determined to be a regular alarm manner.

Optionally, when an alarm time passes in the electronic terminal, the obtained use end time of the electronic terminal is cleared, and/or the alarm manner of the electronic terminal is determined to be a regular alarm manner.

The regular alarm manner may be any one of the foregoing first alarm manner and second alarm manner, or may be another alarm manner. The regular alarm manner includes any one or a combination of a ringing volume, a ringtone type, whether vibration is enabled, and the like.

It may be understood that, after an alarm time passes in the terminal, the obtained use end time of the terminal no longer has reference significance. Therefore, when an alarm time passes in the electronic terminal, the obtained use end time of the electronic terminal may be cleared, and/or, the alarm manner of the electronic terminal may be determined to be a regular alarm manner.

In addition, when the time difference from the use end time of the electronic terminal to the alarm time is excessively large, for example, over 24 hours, the use end time has little reference significance. Therefore, the second threshold may be set to 12 hours or 24 hours, which is not limited in this embodiment of the present disclosure. When the time difference is greater than the second threshold, the obtained use end time of the electronic terminal is cleared, and/or, the alarm manner of the electronic terminal is determined to be a regular alarm manner.

It may be understood that the method in this embodiment of the present disclosure may be applied to a scenario in which multiple electronic terminals are involved.

By means of the manner of implementing an alarm clock provided in this embodiment of the present disclosure, different alarm manners of an alarm clock may be determined according to an obtained time difference from a use end time to an alarm time, which increases flexibility of an alarm manner.

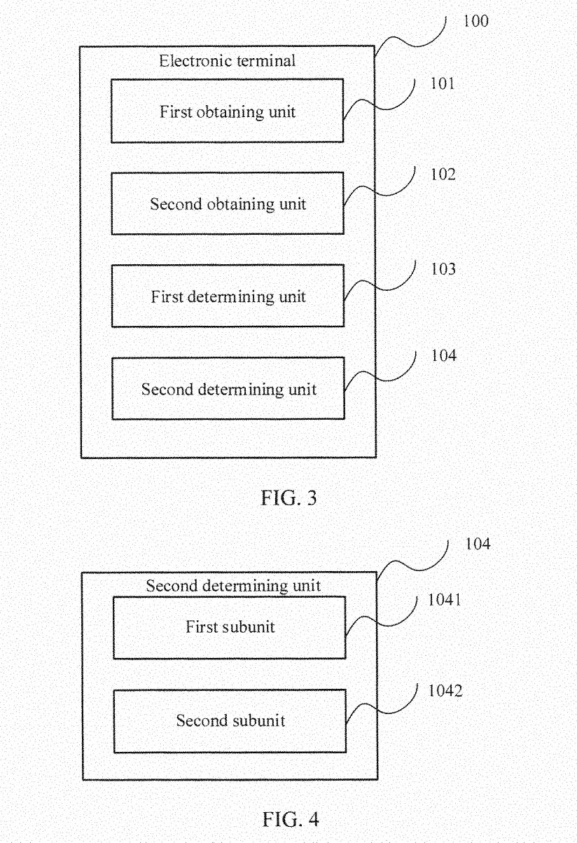

An embodiment of the present disclosure further provides an electronic terminal 100, as shown in FIG. 3.

The electronic terminal 100 includes a first obtaining unit 101 configured to obtain a use end time of the electronic terminal, a second obtaining unit 102 configured to obtain an alarm time of the electronic terminal, a first determining unit 103 configured to determine a time difference from the use end time to the alarm time, and a second determining unit 104 configured to determine an alarm manner of the electronic terminal according to the time difference.

By means of the electronic terminal of an alarm clock provided in this embodiment of the present disclosure, different alarm manners of an alarm clock may be determined according to an obtained time difference from a use end time of the electronic terminal to an alarm time, which increases flexibility of an alarm manner.

Optionally, the first obtaining unit 101 is further configured to obtain the use end time of the electronic terminal after the electronic terminal enters a determining time.

Optionally, the first obtaining unit 101 is further configured to obtain the use end time of the electronic terminal when a use time is greater than a preset time value.

Optionally, the second obtaining unit 102 is further configured to obtain the alarm time of the electronic terminal, where the alarm time refers to an alarm time of an alarm clock that is selected by a user.

Referring to FIG. 4, optionally, the second determining unit 104 further includes a first subunit 1041 configured to determine that the electronic terminal 100 uses a first alarm manner when the time difference is less than a first threshold.

Optionally, the second determining unit 104 further includes a second subunit 1042 configured to determine that the electronic terminal 100 uses a second alarm manner when the time difference is greater than a first threshold.

Optionally, a volume of the first alarm manner is greater than a volume of the second alarm manner.

Optionally, music of the first alarm manner is different from music of the second alarm manner.

Optionally, the first alarm manner includes vibration, and the second alarm manner does not include vibration.

It should be noted that, in the foregoing solution, “greater than” includes a case of “greater than or greater than or equal to”, and “less than” includes a case of “less than or less than or equal to”.

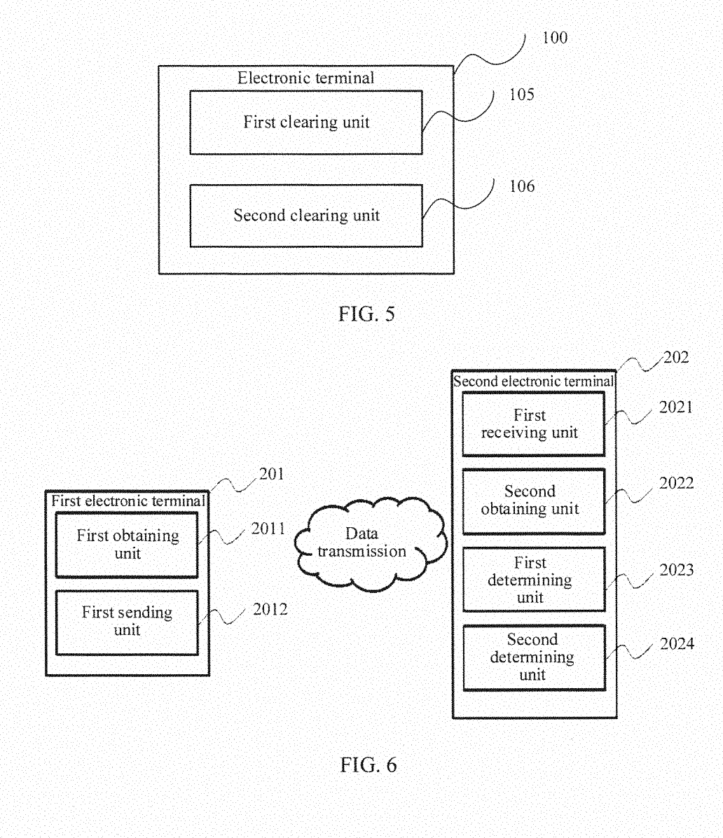

Referring to FIG. 5, optionally, the electronic terminal 100 further includes a first clearing unit 105 configured to clear the obtained use end time of the electronic terminal, or determine that the alarm manner of the electronic terminal is a regular alarm manner when the time difference is greater than a second threshold.

Optionally, the electronic terminal 100 further includes a second clearing unit 106 configured to clear the obtained use end time of the electronic terminal 100, or determine that the alarm manner of the electronic terminal 100 is a regular alarm manner when the alarm time passes in the electronic terminal 100.

It should be noted that, reference may be made to the forgoing method embodiment for detailed description of functions of units in the foregoing electronic terminal that are not described in detail, and details are not described herein again.

By means of the electronic terminal 100 provided in this embodiment of the present disclosure, different alarm manners of an alarm clock may be determined according to an obtained time difference from a use end time of the electronic terminal 100 to an alarm time, which increases flexibility of an alarm manner.

An embodiment of the present disclosure further provides an alarm clock system. Referring to FIG. 6, the system includes a first electronic terminal 201 and a second electronic terminal 202.

The first electronic terminal 201 includes a first obtaining unit 2011 configured to obtain a use end time of the first electronic terminal 201, and a first sending unit 2012 configured to send the use end time of the first electronic terminal 201 to the second electronic terminal 202.

The second electronic terminal 202 includes a first receiving unit 2021 configured to receive the use end time of the first electronic terminal, a second obtaining unit 2022 configured to obtain an alarm time of the second electronic terminal 202, a first determining unit 2023 configured to determine a time difference from the use end time to the alarm time, and a second determining unit 2024 configured to determine an alarm manner of the second electronic terminal 202 according to the time difference.

Data transmission between the first electronic terminal 201 and the second electronic terminal 202 may be implemented using a wireless communication manner such as WI-FI, BLUETOOTH or data traffic.

It should be noted that, reference may be made to the forgoing method and apparatus embodiments for detailed description of functions of terminals and units in the foregoing alarm clock system that are not described in detail, and details are not described herein again.

By means of the alarm clock system provided in this embodiment of the present disclosure, different alarm manners of an alarm clock may be determined according to an obtained time difference from a use end time of the first electronic terminal to an alarm time of the second electronic terminal, which increases flexibility of an alarm manner.

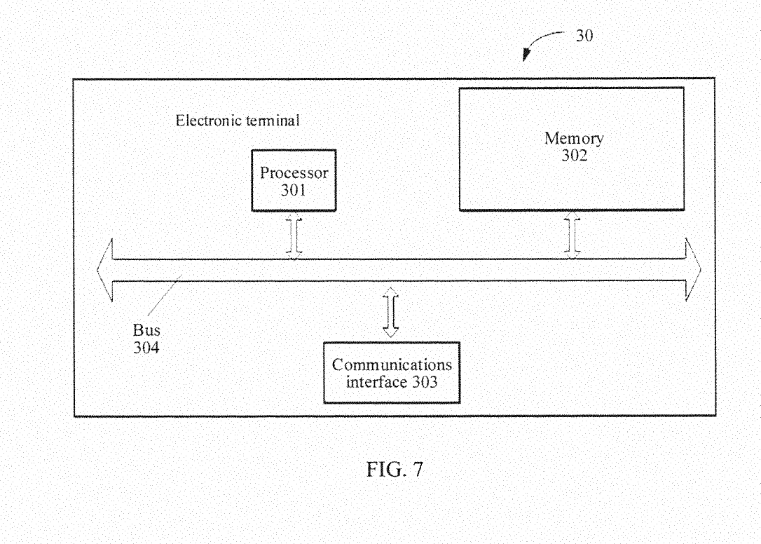

FIG. 7 shows another embodiment of an electronic terminal 30 provided in the present disclosure. The electronic terminal 30 provided in this embodiment includes a processor 301, a memory 302, a communications interface 303, and a bus 304. The processor 301, the memory 302, and the communications interface 303 are connected to and communicate with each other using the bus 304. The bus 304 may be an industry standard architecture (ISA) bus, a peripheral component interconnect (PCI) bus, an extended industry standard architecture (EISA) bus, or the like. The bus 304 may include an address bus, a data bus, a control bus, and the like. For ease of representation, the bus 304 in FIG. 7 is represented using only a simple double arrow, but it does not indicate that there is only one bus or only one type of bus.

The memory 302 is configured to store executable program code, where the program code includes a computer operation instruction. The memory 302 may include a high-speed random access memory (RAM), and may further include a non-volatile memory, for example, at least one magnetic disk memory.

The processor 301 reads executable program code stored in the memory 302 to run a program corresponding to the executable program code in order to obtain a use end time of the electronic terminal, obtain an alarm time of the electronic terminal, determine a time difference from the use end time to the alarm time, and determine an alarm manner of the electronic terminal according to the time difference.

The processor 301 may be a central processing unit (CPU), or an application specific integrated circuit (ASIC), or may be configured into one or more integrated circuits for implementing the embodiments of the present disclosure.

It should be noted that the processor 301 not only has the foregoing functions, but also can be configured to perform other procedures in the foregoing method embodiments, and details are not described herein again.

It should be further noted that reference may be made to the foregoing embodiment of the electronic terminal for division of functional units in the processor 301, and details are not described herein again.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1.-18. (canceled)

19. A method of implementing an alarm clock, applied to an electronic terminal, comprising:
obtaining a use end time of the electronic terminal;
obtaining an alarm time of the electronic terminal;
determining a time difference from the use end time to the alarm time; and
determining an alarm manner of the electronic terminal according to the time difference.

20. The method according to claim 19, wherein obtaining the use end time of the electronic terminal comprises obtaining the use end time of the electronic terminal after the electronic terminal enters a determining time.

21. The method according to claim 19, wherein obtaining the use end time of the electronic terminal comprises obtaining the use end time of the electronic terminal when a use time is greater than a preset time value.

22. The method according to claim 19, wherein obtaining the alarm time of the electronic terminal comprises that the alarm time is an alarm time of an alarm clock selected by a user.

23. The method according to claim 19, wherein determining the alarm manner of the electronic terminal comprises determining that the electronic terminal uses a first alarm manner when the time difference is less than a first threshold.

24. The method according to claim 23, wherein determining the alarm manner of the electronic terminal comprises determining that the electronic terminal uses a second alarm manner when the time difference is greater than the first threshold.

25. The method according to claim 19, wherein when the time difference is greater than a second threshold, the method further comprises:
clearing the obtained use end time of the electronic terminal; and
determining that the alarm manner of the electronic terminal is a regular alarm manner.

26. The method according to claim 19, wherein when the time difference is greater than a second threshold, the method further comprises clearing the obtained use end time of the electronic terminal.

27. The method according to claim 19, wherein when the time difference is greater than a second threshold, the method further comprises determining that the alarm manner of the electronic terminal is a regular alarm manner.

28. The method according to claim 19, wherein when the alarm time passes in the electronic terminal, the method further comprises:
clearing the obtained use end time of the electronic terminal; and
determining that the alarm manner of the electronic terminal is a regular alarm manner.

29. The method according to claim 19, wherein when the alarm time passes in the electronic terminal, the method further comprises clearing the obtained use end time of the electronic terminal.

30. The method according to claim 19, wherein when the alarm time passes in the electronic terminal, the method further comprises determining that the alarm manner of the electronic terminal is a regular alarm manner.

31. An electronic terminal, comprising:
a memory comprising an executable program code; and
a processor coupled to the memory, wherein the executable program code causes the processor to be configured to:
obtain a use end time of the electronic terminal;
obtain an alarm time of the electronic terminal;
determine a time difference from the use end time to the alarm time; and
determine an alarm manner of the electronic terminal according to the time difference.

32. The electronic terminal according to claim 31, wherein the executable program code further causes the processor to be configured to obtain the use end time of the electronic terminal after the electronic terminal enters a determining time.

33. The electronic terminal according to claim 31, wherein the executable program code further causes the processor to be configured to obtain the use end time of the electronic terminal when a use time is greater than a preset time value.

34. The electronic terminal according to claim 31, wherein the executable program code further causes the processor to be configured to determine that the electronic terminal uses a first alarm manner when the time difference is less than a first threshold.

35. The electronic terminal according to claim 31, wherein the executable program code further causes the processor to be configured to determine that the electronic terminal uses a second alarm manner when the time difference is greater than a first threshold.

36. The electronic terminal according to claim 31, wherein when the time difference is greater than a second threshold, the executable program code further causes the processor to be configured to:
clear the obtained use end time of the electronic terminal; or
determine that the alarm manner of the electronic terminal is a regular alarm manner.

37. The electronic terminal according to claim 31, wherein when the alarm time passes in the electronic terminal, the executable program code further causes the processor to be configured to:
clear the obtained use end time of the electronic terminal; or
determine that the alarm manner of the electronic terminal is a regular alarm manner.

38. An alarm clock system, comprising:
a first electronic terminal; and
a second electronic terminal coupled to the first electronic terminal,
wherein the first electronic terminal comprises:
a first memory comprising a first program code; and
a first processor coupled to the first memory, wherein the first program code causes the first processor to be configured to:
obtain a use end time of the first electronic terminal; and
send the use end time of the first electronic terminal to the second electronic terminal, and
wherein the second electronic terminal comprises:
a second memory comprising a second program code; and
a second processor coupled to the second memory, wherein the second program code causes the second processor to be configured to:
receive the use end time of the first electronic terminal;
obtain an alarm time of the second electronic terminal;
determine a time difference from the use end time to the alarm time; and
determine an alarm manner of the second electronic terminal according to the time difference.
